(19) United States
(12) Patent Application Publication
(10) Pub. No.: US 2013/0228257 A1
(43) Pub. Date: Sep. 5, 2013

(54) CHAIN FOR MOUNTING ON A VEHICLE TIRE

(71) Applicant: PEGWAG SCHNEEKETTEN GMNH & CO KG, Bruckl (AT)

(72) Inventor: Agyd Pengg, Portschach (AT)

(73) Assignee: PEWAG SCHNEEKETTEN GMBH & CO KG, Bruckl (AT)

(21) Appl. No.: 13/762,427

(22) Filed: Feb. 8, 2013

(30) Foreign Application Priority Data
Mar. 1, 2012 (AT) A50050/2012

(51) Int. Cl. B60C 27/08

(52) U.S. Cl. CPC B60C 27/08
USPC 152/239

(57) ABSTRACT

The invention relates to a chain for mounting on a vehicle tire, in particular an anti-skid chain, wherein the chain comprises a mesh, which is arranged on the tread of a vehicle tire when the chain is mounted, and is connected to an inner retaining strand on the vehicle tire inner side via inner shoulder chains and to an outer retaining strand on the vehicle tire outer side via outer shoulder chains, wherein the mesh is substantially composed of straight chain links, and the inner shoulder chains are composed of twisted chain links at least in one section, which is arranged on the vehicle tire inner side when the chain is mounted. The invention further relates a chain strand, for example for use in such a chain.

### CROSS REFERENCE TO RELATED APPLICATIONS

This application claims the benefit of Austrian Application No. A50050/2012, filed Mar. 1, 2012.

### BACKGROUND OF THE INVENTION

The invention relates to a chain for mounting on a vehicle tire, in particular an anti-skid chain, wherein the chain comprises a mesh that is composed of chain strands and comprises a central region, which is arranged on the tread of a vehicle tire when the chain is mounted, an inner fringe region, which is connected to an inner retaining strand, and an outer fringe region, which is connected to an outer retaining strand, wherein the central region is located between the inner and outer fringe regions, and the inner fringe region of the chain is arranged on an inner side of the vehicle tire facing the vehicle when the chain is mounted and the outer region is arranged on an outer side of the vehicle tire facing away from the vehicle. The invention further relates to a chain strand for such a chain.

A plurality of chains are known from the prior art, which are intended to prevent especially the driven wheels of a motor vehicle from slipping on paved and unpaved ground. For example, such anti-skid chains are used on work vehicles, which operate on slippery or soft terrain such as mud, snow and frozen soil.

The anti-skid chains generally comprise a chain mesh, which is arranged on the tread of a vehicle tire when the chain is mounted. The chain mesh is typically connected via shoulder chains on the inner and outer sides to retaining strands, which are used to tension the chain mesh or the chain. Such chains are typically implemented with chain strands made of straight or twisted chain links having various cross-sections. The retaining strands can be chains, steel wire ropes or similar solutions.

Known solutions are produced so as to realize all chain links as twisted links, for example in order to have the least possible space requirement or a reduced thickness dimension. However, this comes at the expense of the traction properties of the chains. In contrast, chains that have straight chain links require a lot of space and the use thereof may result in damage to vehicles.

Therefore, it is the object of the invention to provide a chain that overcomes the aforementioned drawbacks of the prior art.

### SUMMARY OF THE INVENTION

This object is achieved by an anti-skid chain according to the invention as described above in that the central region is at least predominantly composed of straight chain links and the inner fringe region is composed of twisted chain links.

The invention provides for a chain, which not only has good traction properties because of the implementation of the central region of the mesh, but also has a reduced thickness dimension on the inner side of the vehicle tire oriented towards the vehicle (this being the vehicle tire inner side). The straight links of the central region of the mesh, which acts as the tread mesh and can be designed in a variety of mesh geometries, have a tractive force-transmitting effect, while the twisted chain links of the inner fringe region are used to attach or tension the chain. In principle, the chain links of the outer fringe region can have any arbitrary design, for example they can likewise contain straight chain links.

The solution according to the invention employs conventional chain links, which are substantially oval having an inner opening and comprise two substantially parallel longitudinal limbs, which are connected to each other via two substantially semi-circular ends. Straight chain links shall be understood to mean chain links the longitudinal limbs of which span a plane, wherein vertical chain links and horizontal chain links are alternatively connected in each chain composite. Vertical and horizontal here shall be understood to mean relative to a vehicle tire surface, wherein in the case of a horizontal chain link the plane spanned by the longitudinal limbs runs parallel to such a surface, while in the case of a vertical chain link the plane spanned by the longitudinal limbs is perpendicular relative to such a surface.

The longitudinal limbs of twisted chain links extend substantially in the opposite direction away from the vehicle tire surface. The mutually opposing ends of the links are counter-twisted (skew). The twisting angle can vary depending on the design.

In principle, the chain links that are used can have various cross-sections, in addition to the property of being twisted or straight. The property of the twisted or straight design is not dependent on the selected cross-section. In addition to a circular cross-section, D-shaped or polygonal cross-sections are also possible, for example. Advantageously, chain links having a square-end cross-section are used at least for the chain links of the central region of the mesh. In a further advantageous embodiment of the invention, the chain links of the inner fringe region and/or the chain links of the outer fringe region are designed as chain links having a rectangular cross-section. The rectangular cross-section, which includes a substantially square or rectangular cross-section, is characterized by particularly good traction properties.

In one variant of the invention, the mesh comprises inner shoulder chains having a first inner shoulder chain section and a second inner shoulder chain section, wherein the first inner shoulder chain section is located in the central region of the mesh and the second inner shoulder chain section is located in the inner fringe region of the mesh. Such inner shoulder chains can be produced from two independent chain strands.

In a first variant of this kind, the first inner shoulder chain section is designed as at least one chain strand that is composed of straight chain links, and the second inner shoulder chain section is designed as at least one chain strand that is composed of twisted chain links, wherein the chain strand of the first inner shoulder chain section and the chain strand of the second inner shoulder chain section are connected to each other via at least one connecting link. For example, the connecting link can be a circular link, however in principle it can have a variety of designs. The chain links of the first and second inner shoulder chain sections are preferably designed as chain links having a square-end cross-section.

In a second variant of the said kind according to the invention, each of the inner shoulder chains is composed of a continuous, unbranched chain strand, wherein the chain links in the first inner shoulder chain section are straight and the chain links in the second inner shoulder chain section are twisted. The chain links of the inner shoulder chain sections are thus identical to each other in terms of material, shape and cross-section; for the production of such inner shoulder chains, an identical chain strand is used, the chain links of which are twisted in one section (which is to rest on the vehicle tire inner side in the mounted state).

In twisted chain links, the mutually opposing ends of the chain links are skew by a certain twisting angle. This also results in a deformation of the longitudinal limbs of the chain link. In principle, the twisting angle can be arbitrary and range between 1° and approximately 100°, or more, for example. In general, in the present invention the twisted chain links are all twisted by the same twisting angle within certain tolerances. According to one variant of the invention, the twisting angle of the twisted chain links of the inner fringe region increases toward the inner retaining strand. While the first chain link immediately connecting to the straight chain links is twisted by a small twisting angle, the twisting angle increases in the direction of the inner retaining strand. The increase can be successively or in steps. For example, the twisting angle can slightly increase with each chain link, however the angle may also change in groups, so that, for example, a certain number of chain links has the same twisting angle and the neighboring group of chain links has a larger twisting angle, and so forth. Arbitrary variants are possible, which are distinguished in that the twisting angle increases in the direction of the inner retaining strand. In general, the reverse design is also possible, of course, which is to say that the twisting angle decreases in the direction of the inner retaining strand. In a further possible variant, the twisting angle first increases and then decreases again in the direction of the inner retaining strand, or vice versa.

The stated object is additionally achieved by a chain strand described at the beginning in that the chain strand is composed of at least one first chain strand section comprising twisted chain links and at least one second chain strand section, which connects to the first, comprising straight chain links, wherein the chain strand is preferably composed of a plurality of such chain strand sections, which are alternately arranged. Such a chain strand can be used to repair a chain described above, for example. In principle, the chain links can have any arbitrary cross-section. Advantageously, the chain links have a square-end cross-section at least in the second chain strand section. However, it is also conceivable to use variants, in which only the links of the second chain strand section, or all chain lengths of the chain strand, have a square-end cross-section. In the case of the twisted chain links, all chain links can have the same twisting angle, however variants as described above, in which the twisting angle increases or decreases over the strand section, are also possible.

Each of the chain strand sections directly connects to the neighboring chain strand sections, or at least one connecting link is arranged in each case between neighboring chain strand sections. Thus, in the first variant described, the individual chain strand sections directly connect to one another; it is possible to use a chain strand having identical chain links, wherein the chain links of the first chain strand section can be twisted during the production process. In the second variant, in principle differently designed chain strand sections—having arbitrary implementations in terms of material, material thickness, shape and cross-section—can be joined to form a chain strand according to the invention.

### BRIEF DESCRIPTION OF THE DRAWINGS

The invention will be described in more detail hereafter based on an exemplary embodiment, which is not limiting and is shown in the drawings. In the drawings, identical elements are denoted by the same reference numerals for clarity. Shown schematically are:

FIG. 1 is the top view onto a chain according to the invention;

FIG. 2 is a sectional view of a first variant of the chain according to the invention;

FIG. 3 is a sectional view of a second variant of the chain according to the invention;

FIG. 4 is a first variant of a chain strand according to the invention; and

FIG. 5 is a second variant of a chain strand according to the invention.

### DETAILED DESCRIPTION OF THE PREFERRED EMBODIMENTS

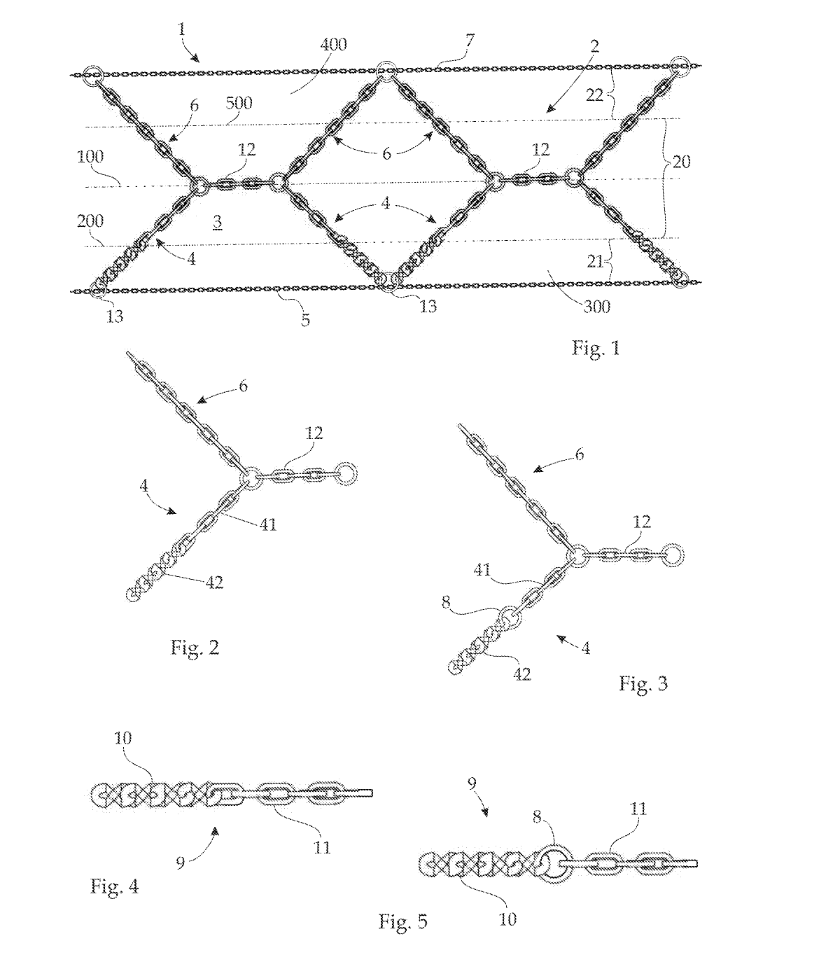

FIG. 1 shows a chain 1 according to the invention in a schematic top view. To provide a better understanding of the chain 1 when it is mounted, FIG. 1 shows the relevant regions of a vehicle tire, these being the tread 3 comprising the center line 100, the inner side of the vehicle tire facing the vehicle (vehicle tire inner side 300) and the outer side of the vehicle tire facing away from the vehicle (vehicle tire outer side 400), and the inner 200 and outer tire edges 500. The inner tire edge 200 separates the tread 3 and the vehicle tire inner side 300, while the outer tire edge 500 separates the tread 3 and the vehicle tire outer side 400. Depending on the tire type, the tire edges 200, 500 are not abrupt edges, but steady transitions between the tread 3 and vehicle tire inner side 300 or outer side 400.

The chain 1 comprises a mesh 2 that is composed of chain strands. The mesh 2 comprises a central region 20, which is arranged on the tread 3 of the vehicle tire when the chain 1 is mounted. The central region 20 is located between an inner fringe region 21 and an outer fringe region 22.

When the chain 1 is mounted, the inner fringe region 21 rests on an inner side of the vehicle tire facing the vehicle, this being the vehicle tire inner side 300. The inner fringe region 21 is connected to an inner retaining strand 5, wherein the inner retaining strand 5 is located on the vehicle tire inner side 300 when the chain is mounted.

When the chain 1 is mounted, the outer fringe region 22 rests on an outer side of the vehicle tire facing away from the vehicle, this being the vehicle tire outer side 400, and is connected to an outer retaining strand 7. The outer retaining strand 7 is located on the vehicle tire outer side 400 when the chain is installed. The chain 1 can be tensioned by way of the retaining strands 5, 7 and thus attached to the vehicle tire.

In the exemplary embodiment shown, traction strands 12 are arranged in the central region 20 of the mesh 2, which are composed of straight chain links and run substantially parallel to the center line 100 of the tread 3 when the chain 1 is mounted. The connection of the mesh 2 to the retaining strands 5, 7 is established by way of shoulder chains 4, 6. Inner shoulder chains 4 connect the traction strands 12 to the inner retaining strand 5 on the vehicle tire inner side 300, while the connection to the outer retaining strand 7 on the vehicle tire outer side 400 is established in corresponding fashion by way of the outer shoulder chains 6. The retaining strands 5, 7 can have any arbitrary design, for example tensioning chains or tensioning ropes.

The connection of the shoulder chains 4, 6 to the retaining strands 5, 7 is established by way of connecting elements 13, which in the exemplary embodiment shown are implemented as ring links. Arbitrary other known designs, for example hooks, are possible as well. Of course, the mesh variant shown is only one of several variants known to a person skilled in the art.

The inner shoulder chains 4 comprise a first inner shoulder chain section 41 and a second inner shoulder chain section 42, wherein the first inner shoulder chain section 41 is located in the central region 20 of the mesh 2 and the second inner shoulder chain section 42 is located in the inner fringe region 21 of the mesh 2.

The outer shoulder chains 6 can likewise be composed of a plurality of sections, however they will not be addressed in detail in the descriptions below. The traction strands 12 and the outer shoulder chains 6 consist of straight chain links. In straight chain links, the longitudinal limbs of the chain link run substantially parallel to each other and span a plane. When the chain is mounted, generally horizontal chain links alternate with vertical chain links; in the case of horizontal chain links, the aforementioned plane is parallel to the tread 3 of the vehicle tire, while the vertical chain links are arranged normal relative to the tread 3.

The straight chain links enable particularly good traction properties of the chain 1, especially in conjunction with a suitable chain link cross-section, which can be constructed as a rectangular cross-section, for example. In the exemplary embodiment shown, the traction-providing running mesh is composed of the traction strands 12 and the chain links of the outer 6 and inner shoulder chains 4 (which is to say of the first inner shoulder chain section 41) located in the central region 20 of the mesh 2. In general, other mesh geometries that are known to a person skilled in the art are also possible, provided that according to the invention at least the chain links that are arranged in the inner fringe region 21 are twisted.

According to the invention, the inner shoulder chains 4 are configured so as to be composed of twisted chain links, at least in the second inner shoulder chain section 42, which is arranged on the vehicle tire inner side 300 when the chain 1 is mounted. The first inner shoulder chain section 41, which is arranged on the tread 3 of the vehicle tire (and forms part of the central region 20 according to the exemplary embodiment shown) when the chain is installed, consists of straight chain links, but can, of course, also consist of twisted chain links. The second inner shoulder chain section 42 comprising the twisted chain links is designed so that already twisted chain links rest on the inner tire edge 200 when the chain is installed. The second inner shoulder chain section 42 starts directly in front of the inner tire edge 200 in the mounted state. Thus, it must be ensured that the twisted chain links of the second inner shoulder chain section 42 rest in this region in the mounted state. The chain links of the shoulder chains 4 preferably likewise have a square-end cross-section.

This solution not only makes particularly good traction properties possible, but also minimizes the space requirement of the second inner shoulder chain sections 42 on the vehicle tire inner side 300. The straight links have a tractive force-transmitting effect, while the twisted links are primarily used to retain the chain 1 on the vehicle tire inner side 300 at a reduced thickness dimension. Because usually there are space constraints in the wheel house or the vehicle tire inner side 300, and a chain 1 having an excessive thickness dimension can result in damage, the chain 1 according to the invention is particularly advantageous.

FIGS. 2 and 3 show detailed views of variants of the chain 1 according to the invention and of the inner shoulder chains 4.

FIG. 2 shows the variant described above. The inner shoulder chain 4 is composed of a continuous, unbranched chain strand, and the chain links have identical designs in terms of shape, material, material thickness and cross-section. During production, a chain strand comprising straight chain links can be produced, wherein in a subsequent work step the chain links of one section of the inner shoulder chain 4, which when the chain is mounted forms the second inner shoulder chain section 42, are twisted.

The first inner shoulder chain section 41 comprising straight chain links, which is arranged on the tread 3 when the chain is mounted, thus transitions directly into the second inner shoulder chain section 42 comprising twisted chain links, which is arranged on the vehicle tire inner side 300.

FIG. 3 shows a second variant, in which the first inner shoulder chain section 41 is designed as at least one chain strand comprising straight chain links, and the second inner shoulder chain section 42 is designed as at least one chain strand comprising twisted chain links, wherein the first inner shoulder chain section 41 and the second inner shoulder chain section 42 are connected to each other via at least one connecting link 8. The shoulder chain sections 41, 42 can also be composed of a plurality of chain strands, respectively. For example, the connecting link 8 can be designed as a ring, and of course arbitrary other embodiments of the connecting link 8 are possible, for example hooks, double rings or the like.

The two shoulder chain sections 41, 42 are thus implemented as separate chain strands, which are connected via the connecting link 8. The shoulder chain sections 41, 42 can thus differ in terms of material, material thickness, cross-section and shape.

In twisted chain links, the mutually opposing ends of the chain links are skew, counter-twisted by a certain twisting angle. This also results in a deformation of the longitudinal limbs of the chain link. In principle, the twisting angle can be arbitrary and range between 1° and approximately 100°, or more, for example.

According to a first variant of the invention, the twisted chain links each have the same twisting angle. According to a second variant, which is not shown in the figures, the twisted chain links have differing twisting angles. For example, the twisting angle of the twisted chain links of the inner shoulder chains 4 (or of the second inner shoulder chain section 42) increases toward the inner retaining strand 5. The chain link connecting to the first inner shoulder chain section 41 comprising straight chain links thus has only a small twisting angle, wherein the twisting angle then increases toward the inner retaining strand 5. This increase can be either successive or in steps. Thus, each chain link either has a twisting angle that is slightly greater than the previous chain link, or the twisting angle increases in groups; a group of three chain links, for example, thus has a first twisting angle, the next group, which likewise comprises three, or more, or fewer, chain links, then has a twisting angle that is increased by a certain value.

Of course, the reverse variant is also possible, which is to say that the twisting angle decreases in the direction of the inner retaining strand 5. In a further variant, the twisting angle first increases and then decreases again, or vice versa.

Apart from the chain 1 described above, the invention also relates to separate chain strands, such as those used as shoulder chains 4, 6, for example. For example, such chain strands can be used for repair purposes for the above chain 1, however different fields of applications are also possible.

FIG. 4 shows a chain strand 9 of such kind according to the invention in a first variant, wherein the chain strand 9 comprises at least one first chain strand section 10 comprising twisted chain links and at least one second chain strand section 11 comprising straight chain links. Each of the two chain strand sections 11, 12 directly connect to the neighboring chain strand sections, whereby the chain strand 9 can be produced from identical straight chain links, for example, wherein chain links are then twisted in sections during production.

Although FIG. 4 shows only one chain strand section 11, 12, the chain strand 9 is preferably composed of a plurality of such chain strand sections, which are alternately arranged. The number of chain links of the individual sections can be arbitrary; the first 10 and the second chain strand section 11 can comprise the same number or differing numbers of chain links.

FIG. 5 shows a second variant, according to which the respective aforementioned chain strand sections 11, 12 are separated from each other by at least one connecting link 8. The connecting link 8 can be designed as a ring link, for example. Such a chain strand 9 can be composed of chain strand sections 11, 12 having a variety of designs.

While the principles of the invention have been described above in connection with preferred embodiments, it is to be clearly understood that this description is made only by way of example and not as a limitation of the scope of the invention.

1. A chain for mounting on a vehicle tire, in particular an anti-skid chain, wherein the chain comprises a mesh that is composed of chain strands and has:
a central region, which is arranged on the tread of a vehicle tire when the chain is mounted;
an inner fringe region, which is connected to an inner retaining strand; and
an outer fringe region, which is connected to an outer retaining strand
wherein the central region is located between the inner and the outer fringe region, and when the chain is mounted, the inner fringe region of the chain is arranged on an inner side of the vehicle tire facing the vehicle, and the outer fringe region is arranged on an outer sides of the vehicle tire facing away from the vehicle, characterized in that the central region is composed, at least predominantly, of straight chain links and the inner fringe region is composed of twisted chain links.

2. The chain according to claim 1, characterized in that the chain links of the central region are designed as chain links having a rectangular cross-section.

3. The chain according to claim 1, characterized in that the chain links of the inner fringe region and/or the chain links of the outer fringe region are designed as chain links having a rectangular cross-section.

4. A chain according to claim 1, characterized in that the mesh comprises inner shoulder chains having a first inner shoulder chain section and a second inner shoulder chain section, wherein the first inner shoulder chain section is located in the central region of the mesh and the second inner shoulder chain section is located in the inner fringe region of the mesh.

5. The chain according to claim 4, characterized in that the first inner shoulder chain section is designed as at least one chain strand that is composed of straight chain links, and the second inner shoulder chain section is designed as at least one chain strand that is composed of twisted chain links, wherein the chain strand of the first inner shoulder chain section and the chain strand of the second inner shoulder chain section are connected to each other via at least one connecting link.

6. The chain according to claim 4, characterized in that each of the inner shoulder chains is composed of a continuous, unbranched chain strand, wherein the chain links in the first inner shoulder chain section are straight and the chain links in the second inner shoulder chain section are twisted.

7. A chain according to claim 1, characterized in that the twisting angle of the twisted chain links of the inner fringe region increases toward the inner retaining strand.

8. A chain strand for a chain according to claim 1, characterized in that the chain strand is composed of at least one first chain strand section comprising twisted chain links and at least one second chain strand section, which connects to the first chain strand section, comprising straight chain links, wherein the chain strand is preferably composed of a plurality of such chain strand sections, which are alternately arranged.

9. The chain strand according to claim 8, characterized in that each of the chain strand sections are directly connected to the neighboring chain strand sections, or at least one connecting link is arranged between respective neighboring chain strand sections.
